(19) United States
(12) Patent Application Publication
(10) Pub. No.: US 2026/0004576 A1
(43) Pub. Date: Jan. 1, 2026

(54) ANNOTATION WORK SUPPORT SYSTEM, ANNOTATION WORK SUPPORT METHOD, AND STORAGE MEDIUM

(71) Applicant: Evident Corporation, Kamiina-gun (JP)

(72) Inventors: Yuki ARAI, Kamiina-gun (JP); Sho MAKITA, Kamiina-gun (JP); Yosuke TANI, Kamiina-gun (JP); Hiroshi TAKISAWA, Kamiina-gun (JP); Takuma DEZAWA, Kamiina-gun (JP)

(73) Assignee: Evident Corporation, Kamiina-gun (JP)

(21) Appl. No.: 19/071,776

(22) Filed: Mar. 6, 2025

(30) Foreign Application Priority Data
Jun. 26, 2024 (JP) 2024-102454

(51) Int. Cl. G06V 10/96; G06V 10/764; G06V 20/40; G06V 20/69; G06V 20/70

(52) U.S. Cl. CPC G06V 10/96; G06V 10/764; G06V 20/41; G06V 20/698; G06V 20/70

(57) ABSTRACT

A storage stores at least one trained models trained by using at least one microscopic videos, microscopic videos associated with each of the trained models, annotation information (including classifications for video segments included in the microscopic videos) indicating annotations assigned to the microscopic videos, and classification criterion information indicating a classification assignment criterion. The processor receives a selection of at least one trained model, acquires microscopic videos, annotation information, and classification criterion information associated with the selected trained model from the storage, displays the acquired microscopic videos and the acquired annotation information in association with each other on a display, and displays the acquired classification criterion information on the display.

### CROSS REFERENCE TO RELATED APPLICATIONS

This application is based upon and claims the benefit of priority of the prior Japanese Patent Application No. 2024-102454, filed Jun. 26, 2024, the entire contents of which are incorporated herein by reference.

### BACKGROUND OF THE INVENTION

### Field of the Invention

The disclosure in the present specification relates to an annotation work support system, an annotation work support method, and a storage medium.

### Description of the Related Art

A technology for supporting creation of teaching data for machine learning of learning data to be used to classify an object from the form of the object obtained by imaging a carrier carrying a cell, has been known (for example, see JP 2017-009314 A). In this technology, a teaching image including an object for creating teaching data is displayed on a display unit, so that the object can be classified by a user.

In addition, the technology called TMRNet has been known as a technology for recognizing an action for a task from a video of the task (for example, see Yueming Jin, et al., “Temporal Memory Relation Network for Workflow Recognition from Surgical Video”, IEEE Transactions on Medical Imaging, Volume 40, Issue 7, July 2021). TMRNet is an abbreviation for temporal memory relation network, and is a technology for specifying what task an action shown in a current frame is on the basis of a relationship between a plurality of frames.

### SUMMARY OF THE INVENTION

An annotation work support system according to an aspect of the present invention includes a storage and a processor. The storage stores at least one trained models trained by using at least one microscopic videos, microscopic videos associated with each of the trained models, annotation information associated with each of the trained models and indicating annotations assigned to the microscopic videos, the annotation information including classifications for video segments included in the microscopic videos, and classification criterion information associated with each of the trained models and indicating a classification assignment criterion. The processor receives a selection of at least one trained model, acquires microscopic videos, annotation information, and classification criterion information associated with the selected trained model from the storage, displays the acquired microscopic videos and the acquired annotation information in association with each other on a display, and displays the acquired classification criterion information on the display.

### BRIEF DESCRIPTION OF THE DRAWINGS

FIG. 1 is a flowchart illustrating an example of a procedure of AI model creation work;

FIG. 2 is a flowchart illustrating an example of a procedure of AI model update work;

FIG. 3 is a diagram illustrating an example of an annotation work support system;

FIG. 4 is a diagram illustrating an example of a hardware configuration of a computer;

FIG. 5 is a diagram illustrating an example of a data structure of a model design information DB;

FIG. 6 is a diagram illustrating the number of the number of class classifications of a video;

FIG. 7 is a diagram illustrating an example of a data structure of a model-related file information DB;

FIG. 8 is a flowchart illustrating processing details in an example of annotation work support processing for re-learning;

FIG. 9 is a diagram illustrating an example of a model selection screen;

FIG. 10 is a flowchart illustrating processing details in an example of annotation work screen processing;

FIG. 11 is a diagram illustrating an example of an annotation work screen;

FIG. 12 is a flowchart illustrating processing details in an example of video segment screen processing;

FIG. 13 is a flowchart illustrating processing details in an example of classification criterion information screen processing;

FIG. 14 is a diagram illustrating an example of an annotation work screen;

FIG. 15 is a flowchart illustrating processing details in an example of first annotation information editing processing;

FIG. 16 is a diagram illustrating an example of an annotation work screen;

FIG. 17 is a flowchart illustrating processing details in an example of second annotation information editing processing;

FIG. 18 is a diagram illustrating an example of a display when a video segment is further divided;

FIG. 19 is a flowchart illustrating processing details in an example of video tag information screen processing;

FIG. 20 is a diagram illustrating an example of a video tag information screen;

FIG. 21 is a flowchart illustrating processing details in an example of re-learning processing;

FIG. 22 is a diagram illustrating another example of a classification criterion information screen; and

FIG. 23 is a diagram illustrating an example in which classification criterion information is edited.

### DESCRIPTION OF THE EMBODIMENTS

An inference model (trained model) generated by machine learning can be used to classify what task a video of a work process captured using a microscope with respect to an object is for. When this trained model is actually used, re-learning may be repeatedly performed to obtain an updated version of the trained model, for example, whenever there is a change in the work process or in order to meet a demand for improvement in classification accuracy.

When re-learning is performed, in order to change the annotations assigned to training videos to be used for re-learning, work of assigning annotations to the training videos (annotation work) may be performed again. Note that the annotation work is work of adding a mark as an annotation at a boundary between two consecutive video segments when a training video is divided into a plurality of video segments for different tasks to assign classifications for different tasks to the respective video segments.

When annotation work is performed again on the training videos to be used for re-learning, information regarding the annotation work previously performed on the training videos (information such as positions at which the training video is divided, classifications assigned to the respective video segments, and the criterion for assigning the classifications) is important in supporting various determinations (determinations as to where the training video is to be divided and what task the training video is to be classified as) required of a person who performs the annotation work.

Hereinafter, embodiments will be described in detail with reference to the drawings.

Even today, when automation of work is progressing using robots or the like, there are still many products that require manual assembly, and a medical device is one example thereof. Precision devices such as medical devices are often assembled under a microscope because many minute tasks are required. For such work, a stereo microscope that allows an object to be viewed in stereoscopic view with both eyes is often used. Such work under the microscope is highly difficult, and prone to variation in work.

In order to suppress variation in work, the responsible of the work may be limited to a trained worker. On the other hand, since the variation in the work depending on the skill level of the person is inevitable, the work under the microscope may be recorded in order to check the state of the work and the appropriateness of the result of the work. As a method of recording the work, a video capturing the state or the result of the work may be acquired by a microscope camera.

The amount of the video obtained in this manner is huge in daily product production. For this reason, it is not realistic for a reviewer to check what task each video segment, which is a part of the video, corresponds to among a series of assembly processes one by one. Therefore, recently, a method has been proposed in which an AI model divides a video that records a series of assembly processes and classifies them for different tasks. Note that “AI” is an abbreviation for artificial intelligence. For example, the above-described TMRNet can be used as an AI model for this purpose.

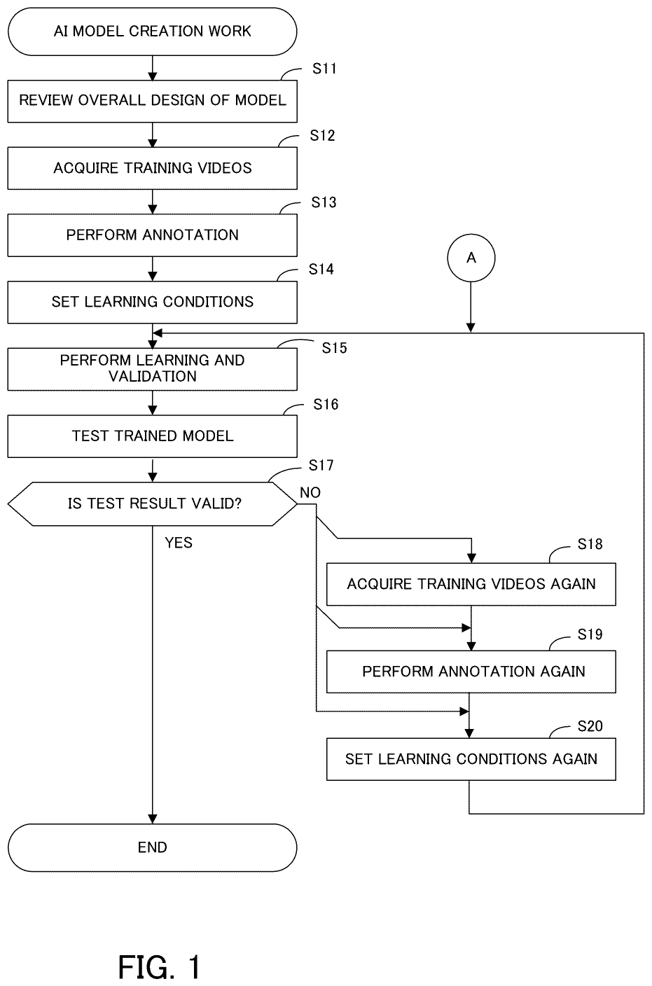

Here, work for creating an AI model that classifies each task in a product assembly process will be described. FIG. 1 is a flowchart illustrating an example of a procedure of AI model creation processing.

In the AI model creation work, first, work of reviewing an overall design (e.g., how many video segments a video is to be divided into and what tasks the video segments are to be classified into) of the AI model to be created is performed (S11). Next, work of acquiring training videos showing tasks in the assembly process is performed (S12).

Next, work of annotating each of the videos acquired by the work in S12 according to the result of the review work in S11 is performed (S13).

Next, work of setting various conditions (learning conditions) in machine learning for creating the AI model is performed (S14). By this setting work, for example, the number of iterations of learning and a threshold for determining convergence of learning are set.

Next, under the learning conditions set by the work in S14, work of performing machine learning and validating a learning result is performed using the training videos including annotations obtained by the work up to S13 as teacher data (S15).

Next, as a test of the AI model obtained as a result of the learning work in S15, work of classifying tasks shown in a video different from the teacher data by the AI model is performed (S16). Then, work of determining whether a result of this test is valid is performed (S17).

Here, when it is determined that the result of the test is valid, the AI model creation processing ends. On the other hand, here, when it is determined that the test result is not valid, work for re-creating an AI model are performed. Specifically, work of acquiring training videos again (S18), work of annotating the videos again (S19), and work of setting learning conditions again (S20) are repeated for trials and errors until it is determined that the result of the test in S16 is valid.

The AI model is completed by, for example, such creation processing.

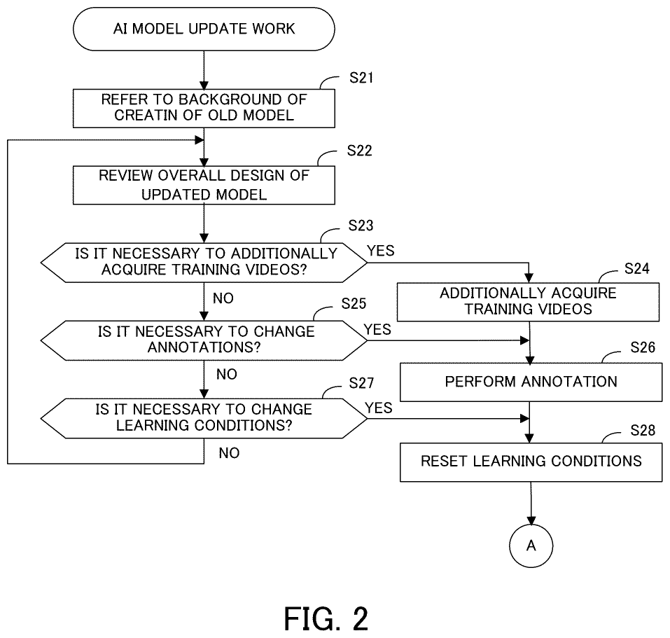

By the way, after the AI model is created, it may be necessary to update the AI model under a certain circumstance such as a change to the assembly process or a demand for improvement in task classification accuracy. Next, AI model update processing will be described. FIG. 2 is a flowchart illustrating an example of a procedure of AI model update processing.

When it is necessary to update the AI model, first, design information at the time of creating the current version of the AI model to be updated and each version before the current version of the AI model to be updated are referred to (S21). Next, work of reviewing an overall design of the updated version of the AI model is performed on the basis of the design information referred to in S21 (S22). Note that the design information includes, for example, the time at which the model was created, information about videos as teacher data, conditions under which the videos were captured, the performance of the model at the time of creation, and information about the worker that is a subject.

By referring to the design information through the work in S21, a model developer who performs the AI model update processing can grasp the intention and the background of the design at the time of creating the old version of the AI model, and obtain an updated version of the AI model capable of grasping the change point from the old version regardless of whether there is a problem in the old version of the AI model derived from the intention and the background of the design.

Next, work of determining whether it is necessary to additionally acquire new training videos different from those used in machine learning for creating the old version of the AI model is performed on the basis of the result of the review work in S22 (S23).

Here, when it is determined that the additional acquisition is necessary, work of additionally acquiring training videos (S24), work of annotating the additionally acquired videos (S26), and work of resetting learning conditions according to the additional acquisition of the videos (S28) are sequentially performed. Then, thereafter, as re-learning work, the work of performing machine learning and validation in S15, the work in S16, and the subsequent work in the AI model creation work illustrated in FIG. 1 are sequentially performed.

On the other hand, when it is determined that it is not necessary to additionally acquire training videos, next, work of determining whether it is necessary to change the annotations added to the already acquired training videos used for creating the old version of the AI model is performed on the basis of the result of the review work in S22 (S25).

Here, when it is determined that it is necessary to change the annotations, work of annotating the acquired training videos to change the annotations (S26) and work of resetting learning conditions accompanying the change of the annotations (S28) are sequentially performed. Then, thereafter, as re-learning work, the work of performing machine learning and validation in S15, the work in S16, and the subsequent work in the AI model creation work illustrated in FIG. 1 are sequentially performed.

On the other hand, when it is determined that both the additional acquisition of training videos and the change of the annotations are unnecessary, next, work of determining whether it is necessary to reset learning conditions is performed on the basis of the result of the review work in S22 (S27).

Here, when it is determined that it is necessary to reset learning conditions, work of resetting learning conditions (S28) is performed. Then, thereafter, as re-learning work, the work of performing machine learning and validation in S15, the work in S16, and the subsequent work in the AI model creation work illustrated in FIG. 1 are sequentially performed.

On the other hand, when it is determined that all of the additional acquisition of training videos, the change of the annotations, and the resetting of learning conditions are unnecessary, the review work in S22 is performed again, and then the work in S23 and the subsequent work are performed again.

In the AI model update work, for example, the above-described work is performed. In this work procedure, when it is determined in S25 that it is necessary to change the annotations, work of annotating the acquired training videos to change the annotations (S26) is performed in S26. At this time, if information regarding the annotation work previously performed on the training videos (information such as positions at which the training video is divided, classifications assigned to the respective video segments, and the criterion for assigning the classifications) can be obtained, the purpose, intention, and the like of the annotation work at that time can be grasped, thereby reducing the burden of annotation work in the AI model update work, that is, annotation work for re-training the trained AI model is reduced.

Therefore, in the following description, as an embodiment of the present invention, a system will be described in which when annotation work for re-training a trained AI model is performed, information regarding annotation work performed previously is displayed for a model developer to support the annotation work.

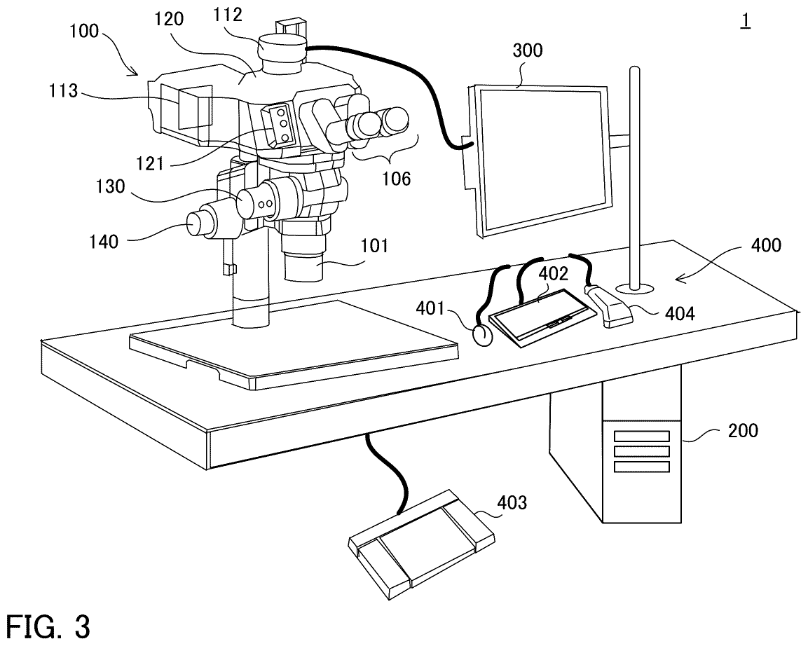

First, FIG. 3 will be described. FIG. 3 illustrates an overall configuration of an example of an annotation work support system 1.

The annotation work support system 1 includes a microscope 100, a control device 200, a monitor 300, and a plurality of input devices 400 (a mouse 401, a keyboard 402, a foot switch 403, a barcode reader 404).

The microscope 100 is a stereoscopic microscope capable of stereoscopically viewing a sample. A user can observe an optical image formed on an object side of an eyepiece 106 by a microscope optical system with the left and right eyes via the eyepiece 106, and can stereoscopically observe the object. The microscope 100 is suitable for use, for example, in work of assembling a precision device.

The microscope 100 includes a zoom lens operable using a zoom handle 130. By operating the zoom handle 130, the user can change the observation magnification while continuing to look into the eyepiece 106 and observe the object.

The microscope 100 includes a focusing handle 140. By operating the focusing handle 140, the user can change the distance between the object and an objective lens 101 to focus on the object.

The microscope 100 includes an imaging device 112 that images the object and acquires a video (microscopic video) of the object. An eyepiece barrel 120 to which the eyepiece 106 is attached is a trinocular lens barrel, and the imaging device 112 is attached to the eyepiece barrel 120. The imaging device 112 includes a two-dimensional image sensor. The image sensor is not particularly limited, and is, for example, a CCD image sensor, a CMOS image sensor, or the like. The video acquired by the imaging device 112 is output to the control device 200. Furthermore, the video may be directly output to the monitor 300.

Light branched by, for example, a beam splitter such as a half mirror from an optical path of an optical system (not illustrated) included in the microscope 100 is incident on the imaging device 112 via an image forming lens (not illustrated).

The microscope 100 includes a projector 113 that projects an auxiliary image on an image plane where the image forming lens forms an optical image. The projector 113 is a device that projects and superimposes an auxiliary image on an image plane in accordance with a command from the control device 200. More specifically, the projector 113 superimposes the auxiliary image on the image plane on the basis of auxiliary image data to be described later. Note that the type of the projector 113 is not particularly limited. The projector 113 may be configured, for example, using a liquid crystal device or a digital mirror device.

The projector 113 is provided in the eyepiece barrel 120. Light from the projector 113 is guided to the optical path of the optical system of the microscope 100.

The eyepiece barrel 120 includes an operation unit 121. By operating the operation unit 121, the user can switch on and off the projector 113 to give an instruction for starting or stopping superimposing an auxiliary image on the image plane.

The control device 200 controls the microscope 100. The control device 200 generates the auxiliary image data described above and outputs the auxiliary image data to the microscope 100 (the projector 113).

The monitor 300 and the input devices 400 are connected to the control device 200. The monitor 300 is, for example, a liquid crystal display, an organic EL display, or the like, and functions as a display in the annotation work support system 1. The “EL” is an abbreviation for electro-luminescence.

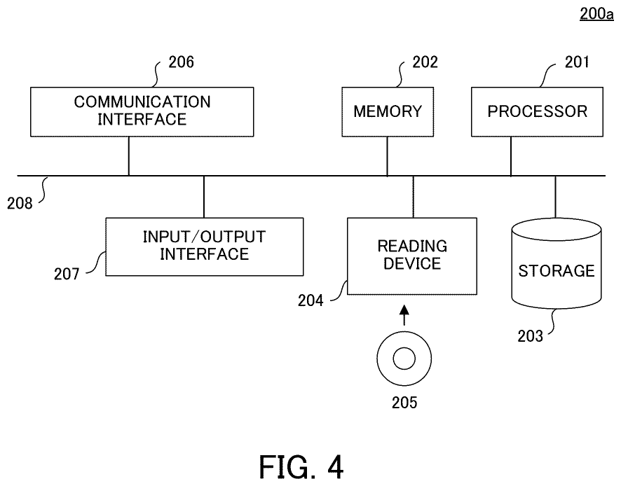

FIG. 4 illustrates an example of a hardware configuration of a computer 200a for realizing the control device 200 in the annotation work support system 1 described above. The computer 200a includes, for example, a processor 201, a memory 202, a storage 203, a reading device 204, a communication interface 206, and an input/output interface 207 as hardware. Note that the processor 201, the memory 202, the storage 203, the reading device 204, the communication interface 206, and the input/output interface 207 are connected to each other, for example, via a bus 208.

The processor 201 may be, for example, a single processor, a multiprocessor, or a multi-core processor. The processor 201 reads and executes programs stored in the storage 203 to perform various types of control processing including annotation work support processing for re-learning to be described later, and provides a function as a control unit in the annotation work support system 1.

The memory 202 is, for example, a semiconductor memory, and may include a RAM area and a ROM area. Note that the “RAM” is an abbreviation for random access memory, and the “ROM” is an abbreviation for read only memory.

The storage 203 is, for example, a semiconductor memory such as a hard disk or a flash memory, or an external storage, and provides a function as a storage unit in the annotation work support system 1. More specifically, the storage 203 stores, for example, configuration data for at least one trained model trained using at least one video captured by the imaging device 112 of the microscope 100. The storage 203 also stores a model design information DB 500, a model-related file information DB 600, and the like, which will be described later. The “DB” is an abbreviation for database.

The reading device 204 accesses a removable recording medium 205, for example, according to an instruction of the processor 201. The removable recording medium 205 is realized, for example, by a semiconductor device, a medium to and from which information is input and output by a magnetic action, a medium to and from which information is input and output by an optical action, or the like. Note that the semiconductor device is, for example, a universal serial bus (USB) memory. Furthermore, the medium to which information is input and output by a magnetic action is, for example, a magnetic disk. The medium to and from which information is input and output by an optical action is, for example, a compact disc (CD)-ROM, a digital versatile disk (DVD), or a Blu-ray (registered trademark) disc, or the like.

The communication interface 206 communicates with other devices (for example, the microscope 100 and the like), for example, according to an instruction of the processor 201. The input/output interface 207 is, for example, an interface between the input device 400 and an output device. The input device 400 is, for example, a device such as the mouse 401, the keyboard 402, the foot switch 403, or the like that receive an instruction from the user. The output device is, for example, the monitor 300 or an audio device such as a speaker. Note that an operation such as a “click operation” to be described below is described as an operation performed by, for example, the mouse 401, but is not limited to a click as long as it is a designation operation using the input device 400.

For example, the programs that the processor 201 executes are provided to the computer in the following forms:
(1) installed in the storage 203 in advance;
(2) provided by the removable recording medium 205; and
(3) provided from a server such as a program server.

Note that the hardware configuration of the computer 200a for realizing the control device 200 described with reference to FIG. 4 is exemplary, and the embodiment is not limited thereto. For example, a part of the configuration described above may be omitted, or a new configuration may be added to the configuration described above. In another embodiment, for example, some or all functions of the control device 200 may be implemented as hardware. A field programmable gate array (FPGA), a system-on-a-chip (SoC), an application specific integrated circuit (ASIC), and a programmable logic device (PLD) are examples of hardware by which the control device 200 can be implemented.

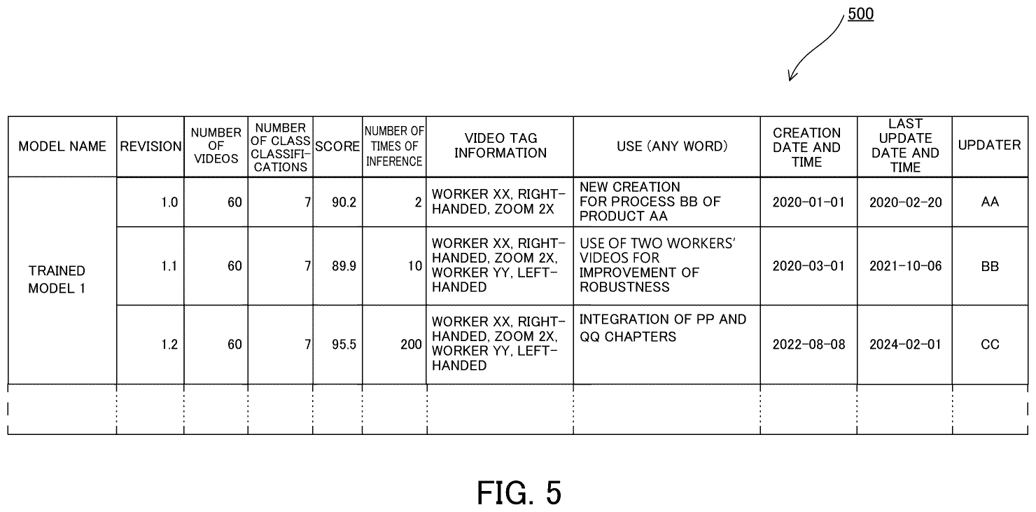

Next, the model design information DB 500 stored in the storage 203 will be described. FIG. 5 illustrates an example of a data structure of the model design information DB 500.

Each of the trained models stored in the storage 203 is associated with version information indicating a version of the trained model. In the model design information DB 500 of FIG. 5, for each trained model, one or a plurality of pieces of version information indicating the version of the trained model and one or a plurality of pieces of design information for the trained model are associated with each other. Note that, in FIG. 5, “model name” is a name given to the AI model (trained model), and “revision” is an example of version information.

The design information is information including at least one of time information, person information, training information, and textual information. In FIG. 5, “the number of videos”, “the number of class classifications”, “score”, and “number of times of inference” are examples of training information, and “video tag information” and “updater” are examples including person information. In addition, “use (any word)” is an example of textual information, and “creation date and time” and “last update date and time” are examples of time information. That is, in the model design information DB 500 of FIG. 5, the design information for the trained model is associated with the “revision” that specifies the version of the trained model.

The design information of FIG. 5 will be further described.

The “number of videos” is information about the number of training videos used for machine learning performed at the time of creating the trained model.

The “number of class classifications is information about the number of classes when the trained model classifies one video obtained by capturing an assembly process with the microscope 100 into video segments for several tasks constituting the assembly process.

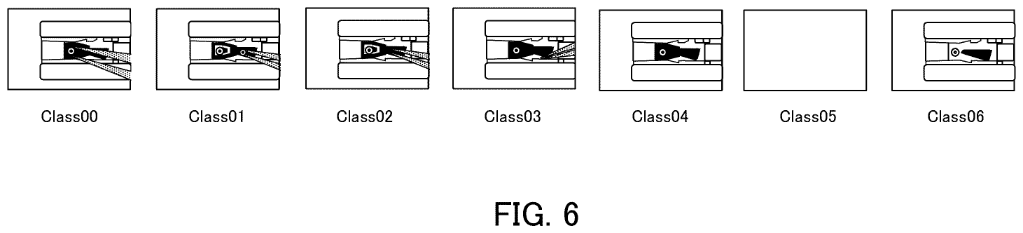

For example, it is indicated in a video of a process of assembling a certain part exemplified in FIG. 6 that one video is classified into video segments from “Class 00” to “Class 06” for tasks constituting the assembly process. Therefore, in this example, the “number of class classifications” is “7”.

Returning to the description with reference to FIG. 5, the “score” is information about a value obtained by quantitatively evaluating the trained model, and is information about a value indicating a level of reliability in the classification from the video of the assembly process into the video segments for the respective tasks performed by the trained model. In the present embodiment, the score is calculated on the basis a convergence value of a loss function calculated during machine learning at the time of creating the trained model. Note that a value calculated by another method may be used as the “score”.

The “number of times of inference” is the number of times of inference performed using the trained model, that is, information about the number of times of classification from the video of the assembly process to video segments for the respective tasks actually using the trained model.

The “video tag information” is tag information added to data of the training videos used for machine learning at the time of creating the trained model. For example, the name of the worker who has performed the task in the assembly process, information about the dominant hand of the worker, and observation information such as the configuration and the observation magnification of the microscope 100 used for capturing the video are attached to the training video for the assembly process stored in the storage 203. The “video tag information” indicates all the tag information attached to each of the training videos used for machine learning.

The “use ((any word))” is textual information expressing information regarding the creation of the trained model, such as an intention and a background of designing the trained model, and is information input by a model developer who created or updated the trained model.

The “creation date and time” is information about the date and time when the trained model was created or updated.

The “last update date and time” is information about the date and time when the design information for the trained model was updated.

The “updater” is information about the name of the model developer who created or updated the trained model.

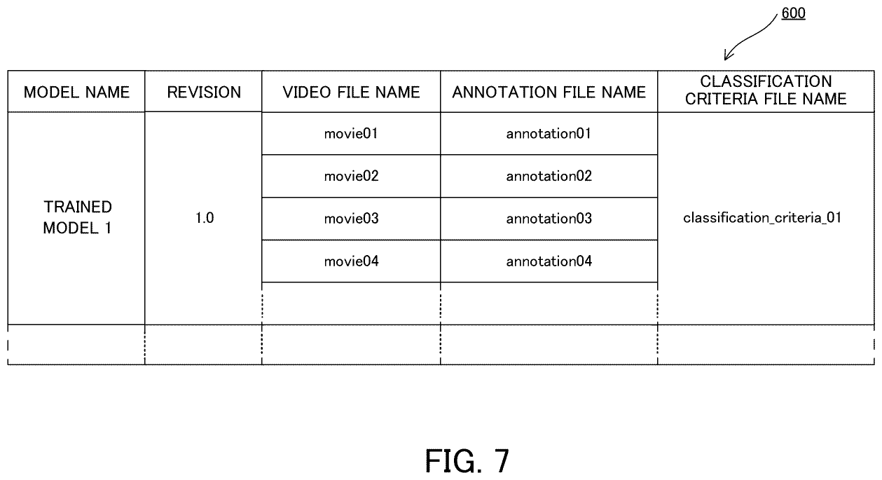

Next, the model-related file information DB 600 stored in the storage 203 will be described. FIG. 7 illustrates an example of a data structure of the model-related file information DB 600.

As described above, the configuration data for the trained model is stored in the storage 203. The storage 203 also stores various data files related to the trained model. The model-related file information DB 600 is used to manage the association between these data files and the trained model.

In the model-related file information DB 600 exemplified in FIG. 7, the “revision” as version information indicating the version of the trained model is associated with a name of a data file stored in the storage 203 for each trained model.

The “video file name” is information about a file name of a video data file of a training video used for machine learning performed at the time of creating the trained model.

The “annotation file name” is information about a file name of an annotation file for the training video indicated by the “video file name” and used for machine learning performed at the time of creating the trained model. The annotation file is a data file in which information (annotation information) indicating annotations added to the training video at the time of the annotation work is stored. The annotation information includes information indicating each division position when the training video is divided into a plurality of video segments for different tasks and information indicating the classifications of the different tasks assigned to the respective video segments. Note that the annotation file stores annotation information for each revision indicating the version of the annotation information, and the annotation information for each revision also includes information such as the revision of the annotation information and the annotation work date.

The “classification criterion file name” is information about a file name of a data file storing classification criterion information indicating the criterion for assigning classifications of different tasks to the respective video segments when the annotations are assigned to each of the training videos indicated by the “video file name” used for machine learning performed at the time of creating the trained model.

In the model-related file information DB 600 exemplified in FIG. 7, annotation files are managed for each revision of the trained model. Alternatively, an annotation file may be managed for each video file. That is, one video file may be associated with one annotation file, and annotation information for the video file may be managed for each revision of the trained model in the corresponding annotation file. Furthermore, annotation information for each revision of the trained model with respect to the video file may be embedded in the video file, and annotations for each revision of the trained model may be managed in the video file.

Next, various kinds of processing performed by the processor 201 will be described.

### [1: Annotation Work Support Processing for Re-Learning]

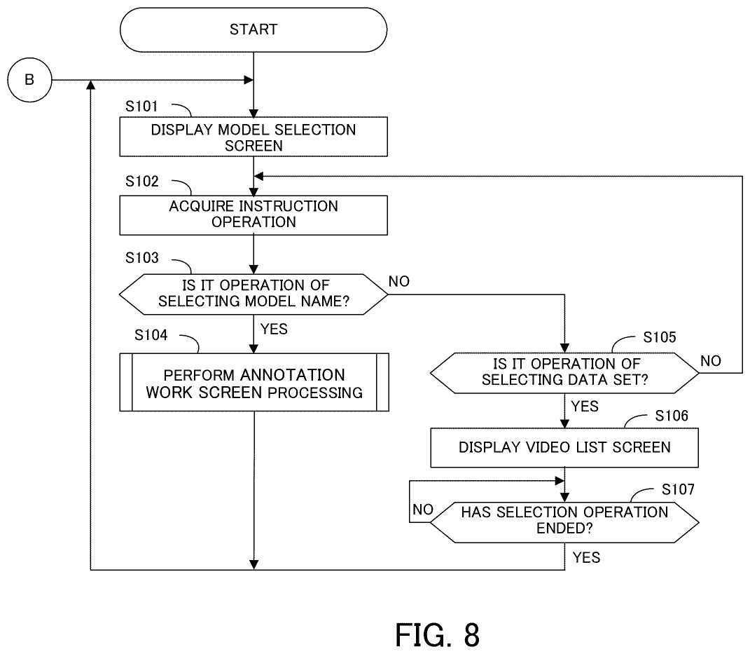

First, annotation work support processing for re-learning will be described. FIG. 8 is a flowchart illustrating processing details in an example of annotation work support processing for re-learning;

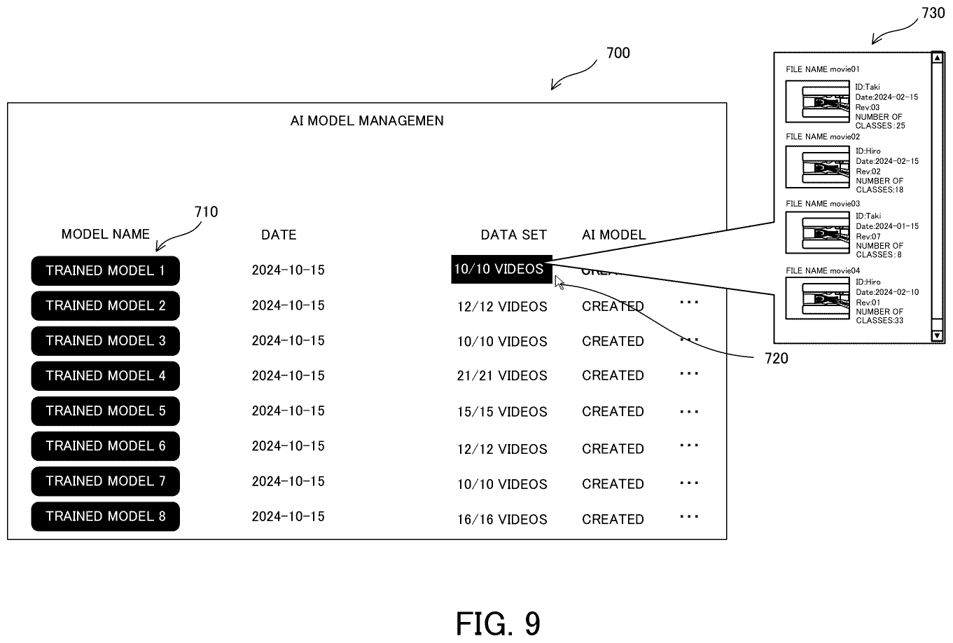

The execution of the annotation work support processing is started when the processor 201 acquires an instruction to start the processing from a model developer who performs annotation work by operating the input device 400. When the execution of the processing is started, first, in S101, a model selection screen 700 illustrated in FIG. 9 is displayed on the monitor 300 connected to the input/output interface 207.

Here, the model selection screen 700 of FIG. 9 will be described. On the model selection screen 700, the following types of information are associated with each other: “model name”, “date”, “data set”, and “AI model”.

The “model name” is a name of an AI model in which configuration data is stored in the storage 203, and the “date” is a date when the AI model is created. These types of information are acquired from the model design information DB 500 described above and displayed on the model selection screen 700.

The “data set” indicates the number of training videos planned to be used for machine learning at the time of creating the AI model and the number of training videos actually used for machine learning. When the numerical values on both sides of the diagonal line in the “data set” are the same, it indicates that all the planned training videos have been used for machine learning.

Furthermore, the “AI model” indicates the status of the creation of the trained model, and the “created” indicates that the creation of the AI model has already been completed. In the example of FIG. 9, all the “AI models” are marked “created”, which indicates that work of creating all the AI models whose model names are displayed on the model selection screen 700 of FIG. 9 has been completed.

Note that the processor 201 generates these kinds of information displayed on the model selection screen 700 by using the information shown in the model design information DB 500 and the model-related file information DB 600.

Referring back to FIG. 8, the description will be made. When the model selection screen 700 is displayed on the monitor 300, next, in S102, an instruction operation on the input device 400 is acquired. Then, in S103, it is determined whether the acquired instruction operation is an operation of selecting a model name of an AI model.

On the model selection screen 700 illustrated in FIG. 9, model selection buttons 710 indicating model names of AI models are arranged as the “model name”. The model selection button 710 is an icon button, and an operation of clicking the model selection button 710 is detected as an operation of selecting the model name of the AI model.

When it is determined in the determination processing of S103 that the acquired operation is for selecting a model name, annotation work screen processing is performed in S104. The annotation work screen processing is processing for switching the screen displayed on the monitor 300 from the model selection screen 700 to an annotation work screen 800 to be described later. This processing will be described in detail later.

Thereafter, when the annotation work screen processing ends, the processing returns to S101, and a model selection screen 700 is displayed again.

On the other hand, when it is determined in the determination processing of S103 that the acquired instruction operation is not an operation of selecting a model name, it is determined whether the instruction operation acquired in S102 is an operation of selecting a data set in S105.

On the model selection screen 700 exemplified in FIG. 9, a mouse pointer 720 points to a position at which the data set for the “trained model 1” is displayed, and an operation of moving the mouse pointer 720 to this position is detected as an operation of selecting a data set.

When it is determined in the determination processing of S105 that the acquired instruction operation is an operation of selecting a data set, a video list screen 730 is displayed in a popped-up manner on the monitor 300 displaying the model selection screen 700 in S106. On the other hand, when it is determined in the determination processing of S105 that the acquired instruction operation is not an operation of selecting a data set, the processing returns to S102, and an instruction operation is acquired again.

Note that the video list screen 730 is a screen displaying a list of information regarding the training videos used for machine learning at the time of generating the AI model specified by the model name corresponding to the data set on which the selection operation has been performed. In the example of FIG. 9, as this information, the creator name (“ID”), the creation date (“Date”), the revision (“Rev”) of the annotation information, and the number of class classifications (“the number of classes”) are shown for the training video. This information is included in the tag information attached to the training video or the annotation file for the training video.

Following the processing of S106, it is determined in S107 whether the operation of selecting the data set acquired by the processing of S102 has ended. This determination processing is repeated until it is determined that the selection operation has ended. When it is determined that the selection operation has ended, the processing returns to S101, and the popped-up display of the video list screen 730 ends and a model selection screen 700 is displayed again.

### [2: Annotation Work Screen Processing]

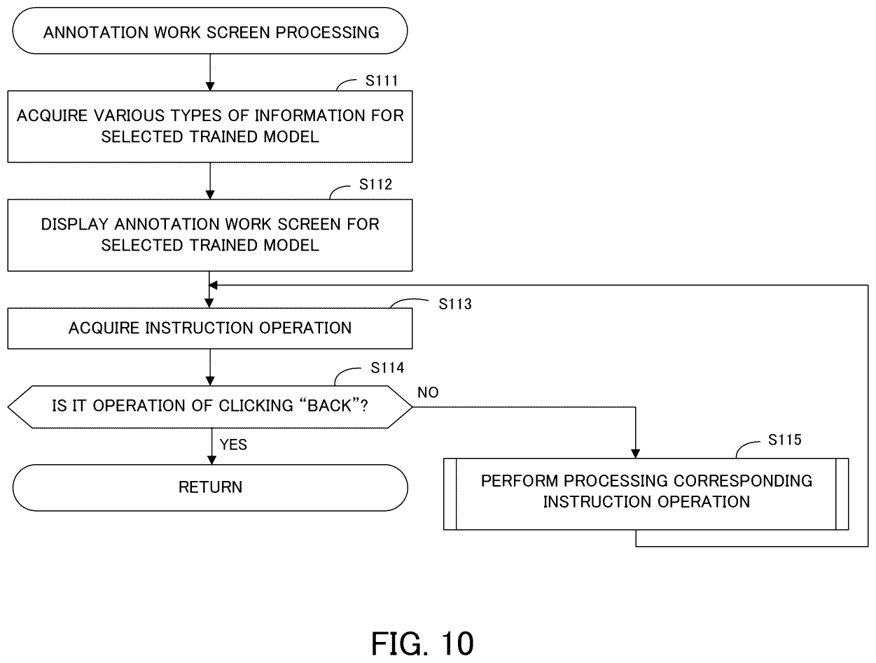

Next, the annotation work screen processing will be described. The annotation work screen processing is processing performed as the processing of S104 when it is determined that the processor 201 has received an operation of selecting an AI model (trained model) in the determination processing of S103 of the annotation work support processing for re-learning of FIG. 8. FIG. 10 is a flowchart illustrating processing details in an example of annotation work screen processing;

When the processing of FIG. 10 is started, first, various types of information for the trained model selected by the operation in the determination processing of S103 of the annotation work support processing for re-learning is acquired from the storage 203 in S111.

Through the processing of S111, one or a plurality of pieces of version information for the selected trained model and design information corresponding to the version information are acquired from the model design information DB 500. Model-related information for the selected trained model is acquired from the model-related file information DB 600. Further, video (training video) data, annotation information, and classification criterion information specified by the file name indicated by the acquired model-related information are acquired from the storage 203. That is, the videos, the annotation information, and the classification criterion information associated with the selected trained model are acquired from the storage 203.

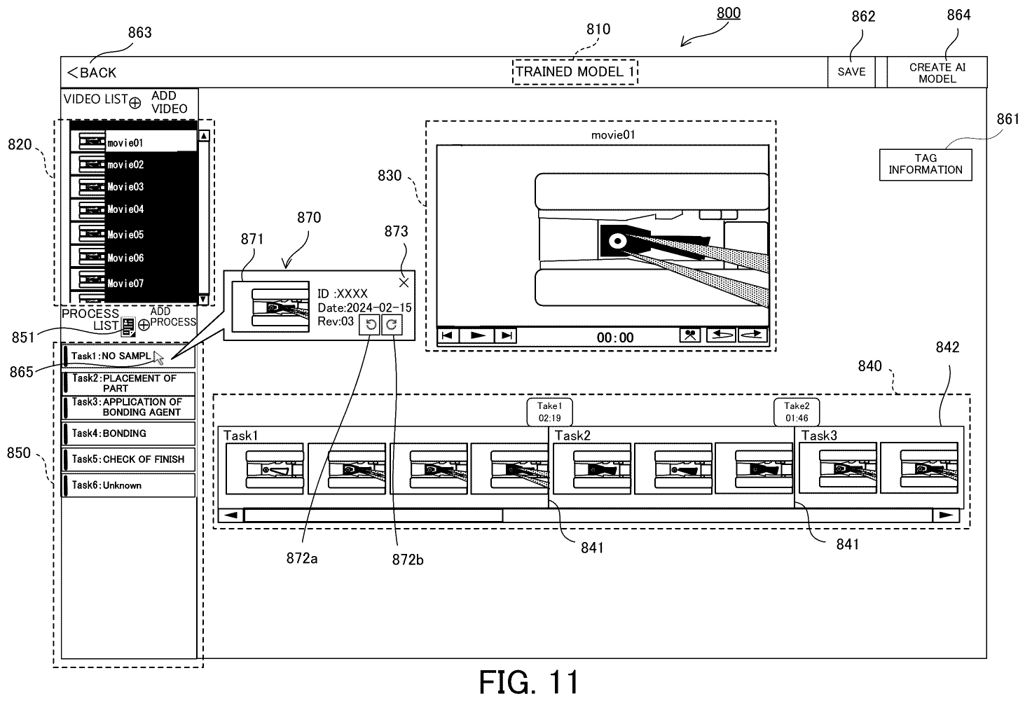

Next, in S112, an annotation work screen 800 exemplified in FIG. 11 is created using the various types of information acquired by the processing of S111, and displayed on the monitor 300.

Here, an example of the annotation work screen 800 will be described.

The annotation work screen 800 has a plurality of display areas 810, 820, 830, 840, and 850.

The processor 201 displays the name of the selected trained model in the display area 810 through the processing of S112. In addition, the processor 201 displays a list of training videos used at the time of training the selected trained model (the trained model of the latest revision in a case where there are a plurality of revisions of the trained model) in the display area 820 through the processing of S112. In the display of the list, one of the displayed training videos is displayed in a selected mode (a mode in which the video file name is shown in black characters on a white background in the example of FIG. 11). The processor 201 displays the training video displayed in the selected mode in the display area 830. In addition, the processor 201 displays the annotation information (the annotation information of the latest revision in a case where there are a plurality of revisions of the annotation information) for the training video displayed in the selected mode in the display areas 840 and 850 through the processing of S112. More specifically, when the training video displayed in the selected mode is divided into a plurality of video segments for different tasks, a mark 841 indicating each division position is superimposed on a timeline 842 of the training video and displayed in the display area 840. In addition, the classifications of the different tasks assigned to the respective video segments are displayed as a list in the display area 850. In the example of FIG. 11, “Task 1: no sample” is displayed as a classification of a task assigned to a first video segment of the training video displayed in the selected mode, and “Task2: part placed” is displayed as a classification of a task assigned to a second video segment of the training video displayed in the selected mode. In this manner, the processor 201 displays the monitor 300 to display the training video displayed in the selected mode and the annotation information for the training video in association with each other.

Note that, when a click operation is performed on a non-selected training video in the display area 820, the selection of the training video is changed, and the processor 201 changes the display of the display areas 830, 840, and 850 according to the newly selected training video.

Referring back to FIG. 10, the description will be made. When the annotation work screen 800 is displayed on the monitor 300 through the processing of S112, next, an instruction operation on the input device 400 is acquired in S113. Then, in S114, it is determined whether the instruction operation acquired by the processing of S113 is an operation of clicking a back button 863 included in the annotation work screen 800. In this determination processing, when it is determined that the instruction operation is an operation of clicking the back button 860, the annotation work screen processing ends, and the processing returns to the annotation work support processing for re-learning in FIG. 8.

On the other hand, when it is determined in the determination processing of S114 that the acquired instruction operation is not an operation of clicking the back button 863, processing corresponding to the acquired instruction operation is executed in S115. Such processing will be described in detail later. Then, when the processing of S115 ends, the processing returns to S113, and an instruction operation is acquired again.

The processing described so far is annotation work screen processing.

In the following description, main processing performed as the processing of S115 in the annotation work screen processing will be described.

### [3: Video Segment Screen Processing]

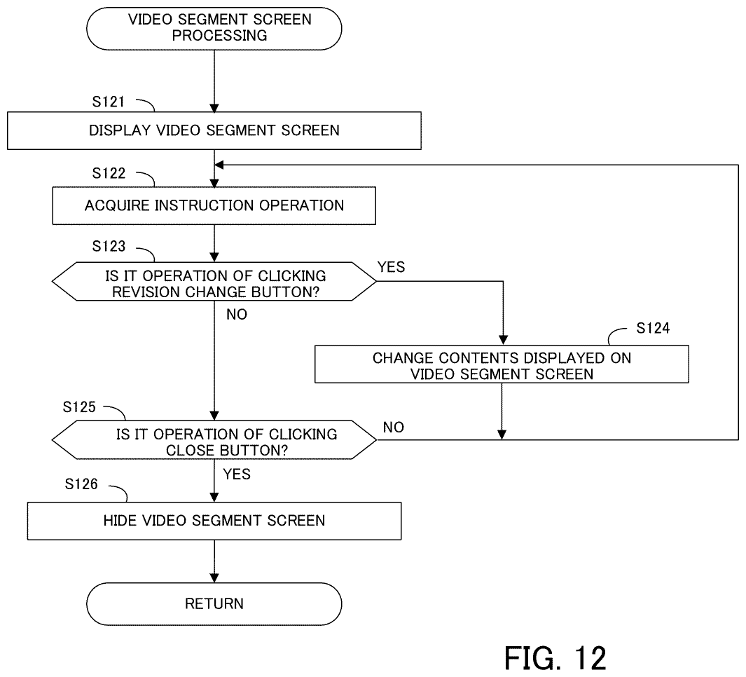

First, video segment screen processing will be described. FIG. 12 is a flowchart illustrating processing details in an example of video segment screen processing;

The video segment screen processing is processing executed by the processor 201 as the processing of S115 in a case where the instruction operation acquired by the processing of S113 in the annotation work screen processing of FIG. 10 is an operation of selecting one of the classifications displayed as a list in the display area 850.

In the display area 850 of the annotation work screen 800 exemplified in FIG. 11, a mouse pointer 865 points to a display area for classification “Task 1: no sample”, and an operation of moving the mouse pointer 865 to this position is detected as an operation of selecting classification “Task 1: no sample”.

When the processing of FIG. 12 is started, first, in S121, a video segment screen 870 is displayed in a popped-up manner on the monitor 300 displaying the annotation work screen 800.

The video segment screen 870 is a screen displaying a frame image (e.g., the last frame image of the video segment) 871 after which the task in the video segment to which the classification selected in the display area 850 is assigned transitions, the model developer name (“ID”), the annotation work date (“Date”), and the revision of the annotation information (“Rev”). Here, the model developer name is included in the design information, and the annotation work date and the revision of the annotation information are included in the annotation information.

Note that the display of the video segment screen 870 in the popped-up manner on the monitor 300 displaying the annotation work screen 800 also means displaying some of the design information in association with the training video displayed in the selected mode.

When the video segment screen 870 is displayed in the popped-up manner on the monitor 300 through the processing of S121, next, an instruction operation on the input device 400 is acquired in S122. Then, in S123, it is determined whether the acquired instruction operation is an operation of clicking a revision change button 872a or 872b included in the video segment screen 870.

When it is determined in the determination processing of S123 that the acquired instruction operation is an operation of clicking the revision change button 872a or 872b, the contents (the frame image 871, the annotation work date, and the revision of the annotation information) displayed on the video segment screen 870 are changed to those of the annotation information of the revision corresponding to the revision change button 872a or 872b on which the click operation has been performed in S124. Specifically, when the acquired instruction operation is an operation of clicking the revision change button 872a, the contents displayed on the video segment screen 870 are changed to those of the annotation information of the one-previous (or one-next) revision. On the other hand, when the acquired instruction operation is an operation of clicking the revision change button 872b, the contents displayed on the video segment screen 870 are changed to those of the annotation information of the one-next (or one-previous) revision. Then, when the processing of S124 ends, the processing returns to S122, and an instruction operation on the input device 400 is acquired again.

When it is determined in the determination processing of S123 that the acquired instruction operation is not an operation of clicking the revision change button 872a or 872b, it is determined whether the instruction operation acquired by the processing of S122 is an operation of clicking a close button 873 included in the video segment screen 870 in S125.

When it is determined in the determination processing of S125 that the acquired instruction operation is not an operation of clicking the close button 873, the processing returns to S122, and an instruction operation on the input device 400 is acquired again.

On the other hand, when it is determined in the determination processing of S125 that the acquired instruction operation is an operation of clicking the close button 873, the video segment screen 870 displayed in the popped-up manner is hidden in S126. Then, when the processing of S126 ends, the video segment screen processing ends, and the processing returns to the annotation work screen processing of FIG. 10.

According to such video segment screen processing, the model developer who performs annotation work can check information such as at what scene the video has been divided into the video segment, who has performed the annotation work, when the annotation work was performed for each revision of the annotation information.

### [4: Video Segment Reproduction Processing]

Next, video segment reproduction processing will be described. The video segment reproduction processing is processing executed by the processor 201 as the processing of S115 in a case where the instruction operation acquired by the processing of S113 in the annotation work screen processing of FIG. 10 is an operation of clicking one of the display areas for the classifications displayed as a list in the display area 850.

In the video segment reproduction processing, the video segment to which the classification of the display area on which the click operation has been performed is assigned or a part of the video segment is reproduced and displayed in the display area 830. Then, when this processing ends, the processing returns to S113, and an instruction operation on the input device 400 is acquired again.

According to such video segment reproduction processing, the model developer who performs annotation work can check the contents in the video segment or the content in a part of the video segment.

### [5: Classification Criterion Information Screen Processing]

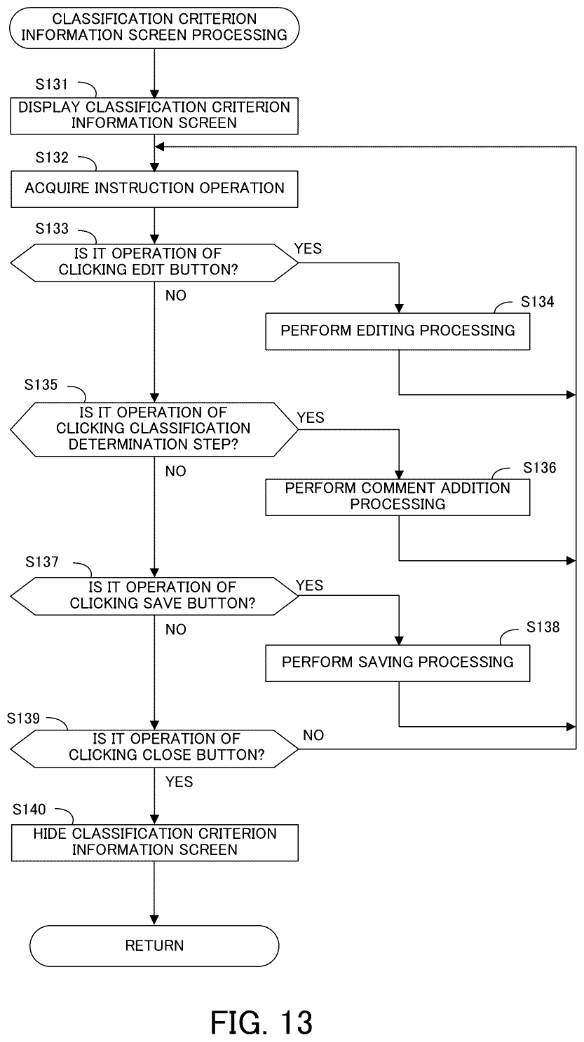

Next, classification criterion information screen processing will be described. The classification criterion information screen processing is processing executed by the processor 201 as the processing of S115 in a case where the instruction operation acquired by the processing of S113 in the annotation work screen processing of FIG. 10 is an operation of clicking a process list icon 851 included in the annotation work screen 800. FIG. 13 is a flowchart illustrating processing details in an example of classification criterion information screen processing;

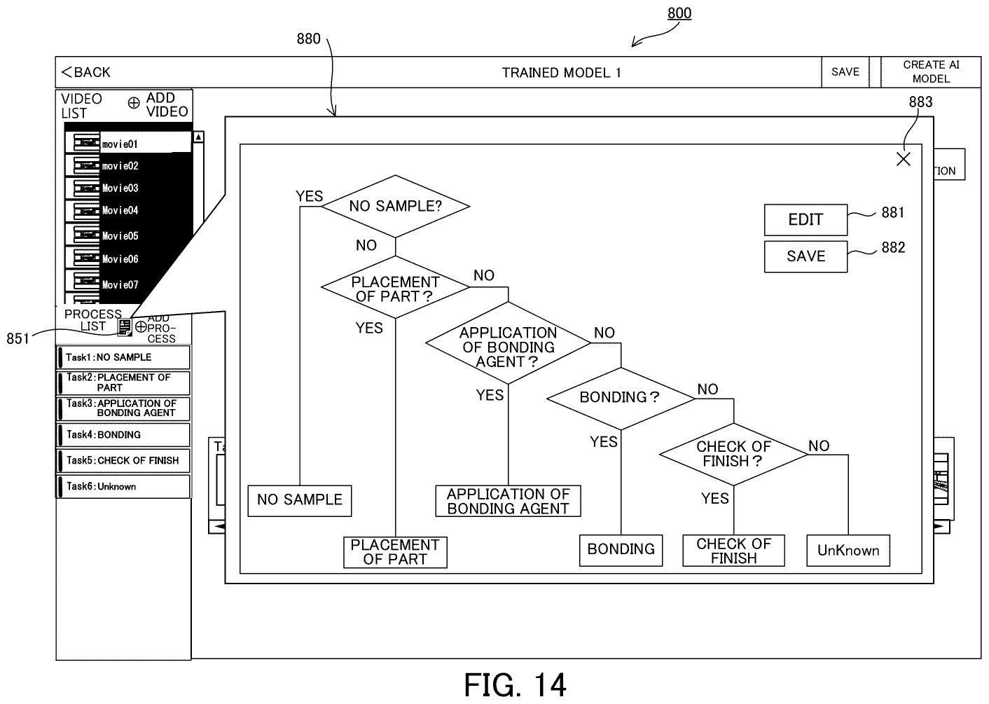

When the processing of FIG. 13 is started, first, in S131, a classification criterion information screen 880 is displayed in a popped-up manner on the monitor 300 displaying an annotation work screen 800 exemplified in FIG. 14.

The classification criterion information screen 880 is a screen displaying classification criterion information acquired by the processing of S111 in the annotation work screen processing of FIG. 10. In the example of FIG. 14, the classification criterion information is shown as a flowchart illustrating a classification assignment procedure. By referring to the classification criterion information screen 880, the model developer who performs annotation work can grasp the criterion by which the annotation information displayed on the annotation work screen 800 (the display areas 840 and 850) is used to divide and classify the selected training video into a plurality of video segments. For example, it can be grasped in the selected training video that a video segment showing a sample and a task of placing a part is classified as a task “placement of part”. Therefore, the model developer can easily perform annotation work for re-learning by referring to the classification criterion information displayed on the classification criterion information screen 880.

When the classification criterion information screen 880 is displayed in the popped-up manner on the monitor 300 through the processing of S131, next, an instruction operation on the input device 400 is acquired in S132. Then, in S133, it is determined whether the acquired instruction operation is an operation of clicking an edit button 881 included in the classification criterion information screen 880.

When it is determined in the determination processing of S133 that the acquired instruction operation is an operation of clicking the edit button 881, next, the classification criterion information is edited in S134. This processing is processing of editing the classification criterion information such as adding, deleting, or correcting a classification procedure with respect to the classification criterion information displayed on the classification criterion information screen 880 according to the operation on the input device 400. Through this processing, the model developer performing annotation work can edit the classification criterion information. When the processing of S134 ends, the processing returns to S132, and an instruction operation on the input device 400 is acquired again.

On the other hand, when it is determined in the determination processing of S133 that the acquired instruction operation is not an operation of clicking the edit button 881, next, it is determined whether the instruction operation acquired by the processing of S132 is an operation of clicking a display area for one (e.g., the classification determination step of “placement of part?”) of the classification determination steps shown in the classification criterion information screen 880 in S135.

When it is determined in the determination processing of S135 that the acquired instruction operation is an operation of clicking a display area for one of the classification determination steps, next, a comment is added in S136. This processing is processing of displaying a comment display field near the classification determination step in the display area on which the click operation has been performed, and displaying a comment input by operating the input device 400 in the comment display field. Through this processing, the model developer who performs annotation work can add a comment to the classification determination step shown in the classification criterion information screen 880. When the processing of S136 ends, the processing returns to S132, and an instruction operation on the input device 400 is acquired again.

On the other hand, when it is determined in the determination processing of S135 that the acquired instruction operation is not an operation of clicking a display area for one of the classification determination steps, next, it is determined whether the instruction operation acquired by the processing of S132 is an operation of clicking a save button 882 included in the classification criterion information screen 880 in S137.

When it is determined in the determination processing of S137 that the acquired instruction operation is an operation of clicking the save button 882, next, saving processing is performed in S138. This processing is processing of saving a classification criterion file storing the classification criterion information (including a comment in a case where the comment display field is displayed) displayed on the classification criterion information screen 880 in the storage 203. Through this processing, the model developer who performs annotation work can save the edited classification criterion information or the comment-added classification criterion information. Note that the classification criterion file saved in the storage 203 at this time is associated with a newly created trained model by the model-related file information DB 600 thereafter when the new trained model is created by re-training the trained model. When the processing of S138 ends, the processing returns to S132, and an instruction operation on the input device 400 is acquired again.

On the other hand, when it is determined in the determination processing of S137 that the acquired instruction operation is not an operation of clicking the save button 882, next, it is determined whether the instruction operation acquired by the processing of S132 is an operation of clicking a close button 883 included in the classification criterion information screen 880 in S139.

When it is determined in the determination processing of S139 that the acquired instruction operation is not an operation of clicking the close button 883, the processing returns to S132, and an instruction operation on the input device 400 is acquired again.

On the other hand, when it is determined in the determination processing of S139 that the acquired instruction operation is an operation of clicking the close button 883, next, the classification criterion information screen 880 displayed in the popped-up manner is hidden in S140. Then, when the processing of S140 ends, the classification criterion information screen processing ends, and the processing returns to the annotation work screen processing of FIG. 10.

### [6: First Annotation Information Editing Processing]

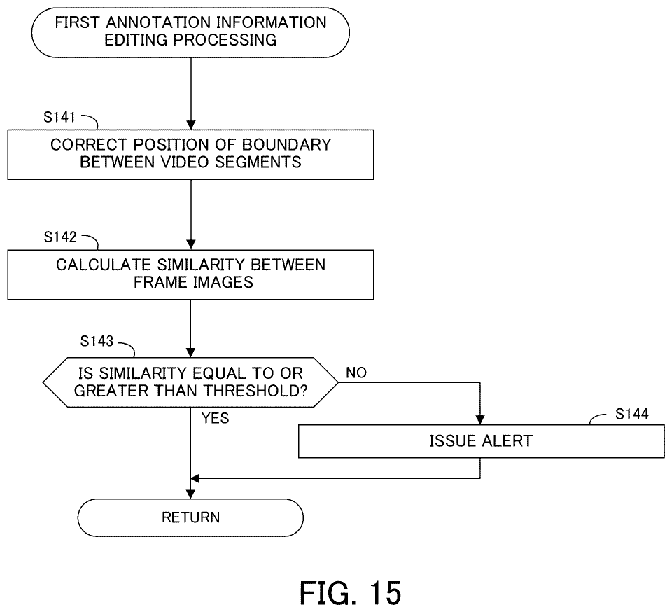

Next, first annotation information editing processing will be described. FIG. 15 is a flowchart illustrating processing details in an example of first annotation information editing processing;

The first annotation information editing processing is processing executed by the processor 201 as the processing of S115 in a case where the instruction operation acquired by the processing of S113 in the annotation work screen processing of FIG. 10 is an operation of correcting a position of a boundary between video segments.

In the annotation work screen 800 exemplified in FIG. 11, an operation of dragging the mark 841 on the timeline 842 in a left or right direction and dropping the mark 841 is detected as an operation of correcting a position of a boundary between video segments.

When the processing of FIG. 15 is started, first, in S141, a position of a boundary between two video segments adjacent to each other with the mark 841 interposed therebetween is corrected according to the position of the mark 841 on which the drag and drop operation has been performed.

Next, in S142, a similarity is calculated between a frame image immediately before (or immediately after) the position of the mark 841 on which the drag and drop operation has been performed and a frame image immediately before (or immediately after) the position of the mark 841 before the drag and drop operation is performed. Then, in S143, it is determined whether the calculated similarity is equal to or greater than a threshold.

When it is determined in the determination processing of S143 that the similarity is not equal to or greater than the threshold, next, an alert is issued to prompt confirmation as to whether the correction of the position of the boundary between the video segments is appropriate in S144. Through this processing, when the contents in the frame image are greatly different before and after the correction of the position of the boundary between the video segments, an alert is issued.

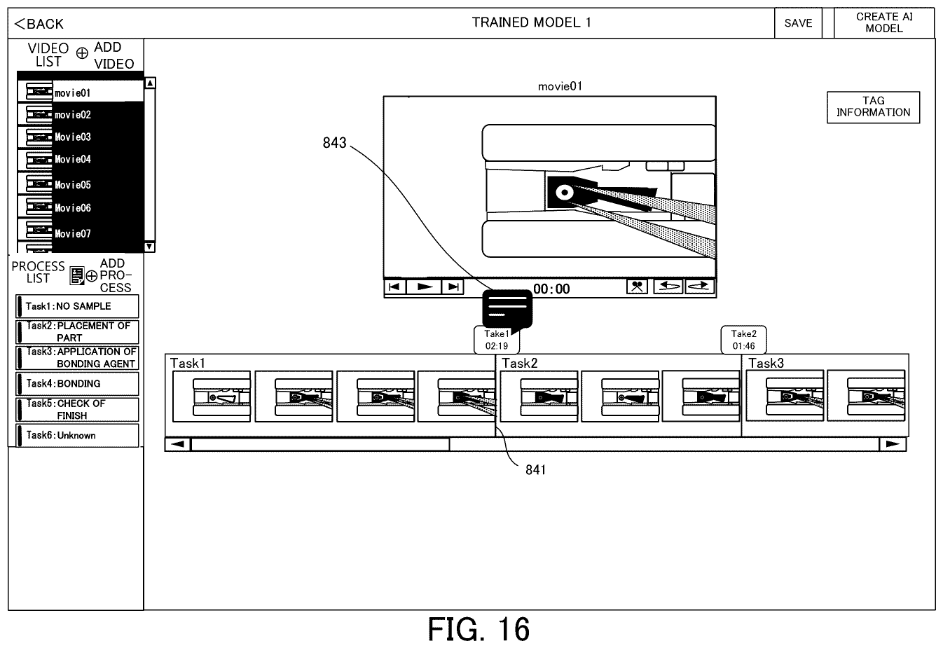

In an annotation work screen 800 exemplified in FIG. 16, when the position of the boundary between the video segment classified as “Task 1: no sample” and the video segment classified as “Task 2: placement of part” is corrected, an alert message 843 is displayed as an alert. Note that the alert may be issued by voice or by both voice and message.

On the other hand, when it is determined that the similarity is equal to or greater than the threshold in the determination processing of S143, the first annotation information editing processing ends, and the processing returns to the annotation work screen processing of FIG. 10.

According to such first annotation information editing processing, the model developer who performs annotation work can correct the division position of the training video. That is, the model developer can correct the annotations. In addition, when the division position is improperly corrected, an alert can be issued to the model developer.

### [7: Second Annotation Information Editing Processing]

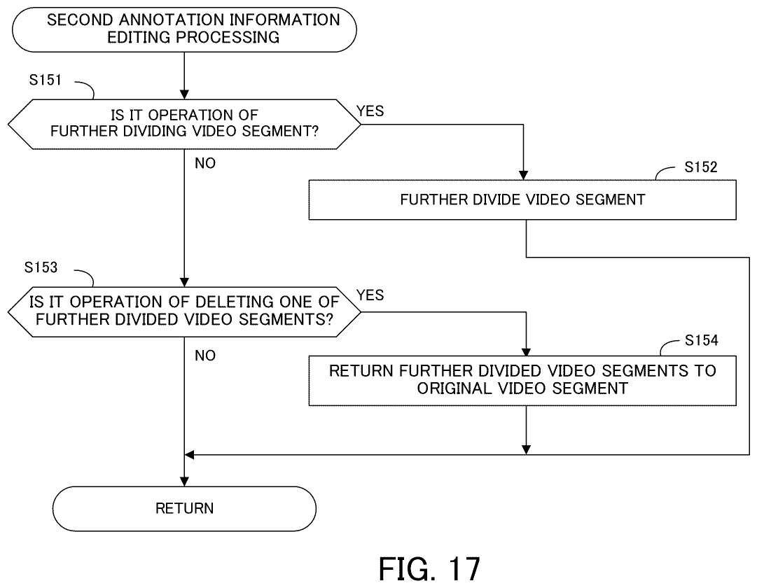

Next, second annotation information editing processing will be described. FIG. 17 is a flowchart illustrating processing details in an example of second annotation information editing processing;

The second annotation information editing processing is processing executed by the processor 201 as the processing of S115 in a case where the instruction operation acquired by the processing of S113 in the annotation work screen processing of FIG. 10 is either an operation of further dividing the video segment or an operation of deleting one of the further divided video segments.

When the processing of FIG. 17 is started, first, in S151, it is determined whether the instruction operation acquired by the processing of S113 is an operation of further dividing the video segment.

In the annotation work screen 800 exemplified in FIG. 11, an operation of clicking any position on the timeline 842 is detected as an operation of further dividing the video segment.

When it is determined in the determination processing of S151 that the acquired instruction operation is the operation of further dividing the video segment, next, the video segment is further divided in S152. In this processing, the video segment at the position where the click operation has been performed on the timeline 842 is further divided at that position. In addition, the contents displayed in the display area 850 are changed accordingly.

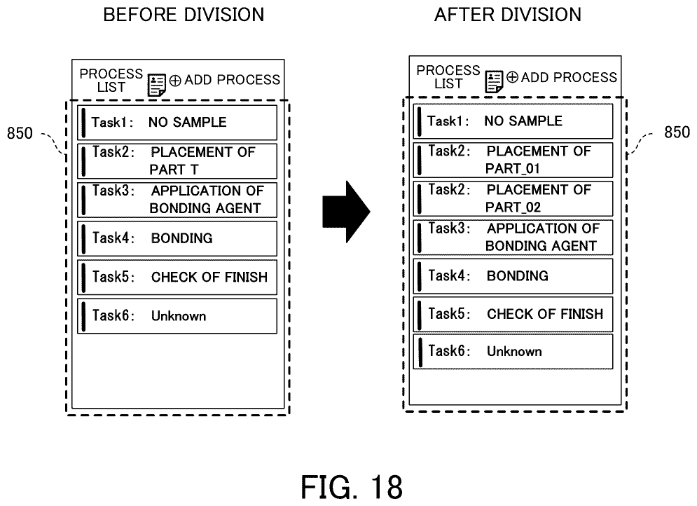

In the annotation work screen 800 exemplified in FIG. 11, for example, when a click operation is performed on any position on the timeline 842 in the video segment classified as “Task 2: placement of part”, the video segment “Task 2: placement of part” is further divided at that position. Accordingly, in the display area 850, as exemplified in FIG. 18, the classification displayed as “Task 2: placement of part” before the division is divided into classification displayed as “Task 2: placement of part_01” and classification displayed as “Task 2: placement of part_02” after the division.

When the processing of S152 ends, the second annotation information editing processing ends, and the processing returns to the annotation work screen processing of FIG. 10.

On the other hand, when it is determined in the determination processing of S151 that the instruction operation acquired by the processing of S113 is not an operation of further dividing the video segment, next, it is determined whether the instruction operation acquired by the processing of S113 is an operation of deleting one of the further divided video segments in S153.

In a display area 850 after the division exemplified in FIG. 18, an operation such as a double click operation or a right click operation on a display area for either “Task 2: placement of part_01” or “Task 2: placement of part_02”, which are classifications of the further divided video segments, is detected as an operation of deleting one of the further divided video segments. For example, when a right click operation is performed, an operation of selecting (clicking) a deletion instruction item from a menu screen displayed in a popped-up manner by the right click operation is detected as an operation of deleting one of the further divided video segments.

When it is determined in the determination processing of S153 that the acquired instruction operation is an operation of deleting one of the further divided video segments, the further divided video segments are returned to the original video segment in S154. In this processing, the further divided video segments are integrated and returned to the original video segment (before the division). Accordingly, the contents displayed in the display area 850 are also returned to the contents displayed before the division.

In the display area 850 after the division exemplified in FIG. 18, when a double click operation is performed on the display area for “Task 2: placement of part_01” or “Task 2: placement of part_02”, the video segment for “Task 2: placement of part_01” and the video segment for “Task 2: placement of part_02” are integrated and returned to the original video segment for “Task 2: placement of part”. Accordingly, the display of the display area 850 after the division is returned to the display of the display area 850 before the division exemplified in FIG. 18.

When the processing of S154 ends, the second annotation information editing processing ends, and the processing returns to the annotation work screen processing of FIG. 10.

On the other hand, when it is determined in the determination processing of S153 that the acquired instruction operation is not an operation of deleting one of the further divided video segments, the second annotation information editing processing ends, and the processing returns to the annotation work screen processing of FIG. 10.

According to such second annotation information editing processing, the model developer who performs annotation work can further divide the video segment or return the further divided video segments to the original video segment. That is, the model developer can add and delete annotations.

### [8: Annotation Information Saving Processing]

Next, annotation information saving processing will be described. The annotation information saving processing is processing executed by the processor 201 as the processing of S115 in a case where the instruction operation acquired by the processing of S113 in the annotation work screen processing of FIG. 10 is an operation of clicking the save button 862 included in the annotation work screen 800.

In the annotation information saving processing, the annotation information displayed in the display areas 840 and 850 of the annotation work screen 800 is saved in the storage 203. More specifically, the annotation information is stored as a new revision of the annotation information in the annotation file associated with the training video displayed in the selected mode. Then, when the annotation information saving processing ends, the processing returns to the annotation work screen processing in FIG. 10.

### [9: Video Tag Information Screen Processing]

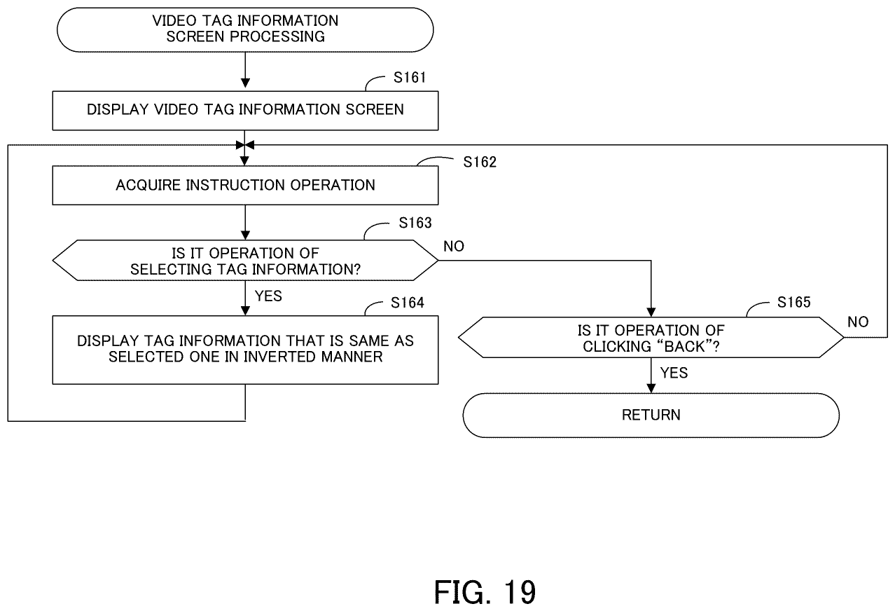

Next, video tag information screen processing will be described. FIG. 19 is a flowchart illustrating processing details in an example of video tag information screen processing.

The video tag information screen processing is executed by the processor 201 as the processing of S115 in a case where the instruction operation acquired by the processing of S113 in the annotation work screen processing of FIG. 10 is an operation of clicking a tag information button 861 included in the annotation work screen 800.

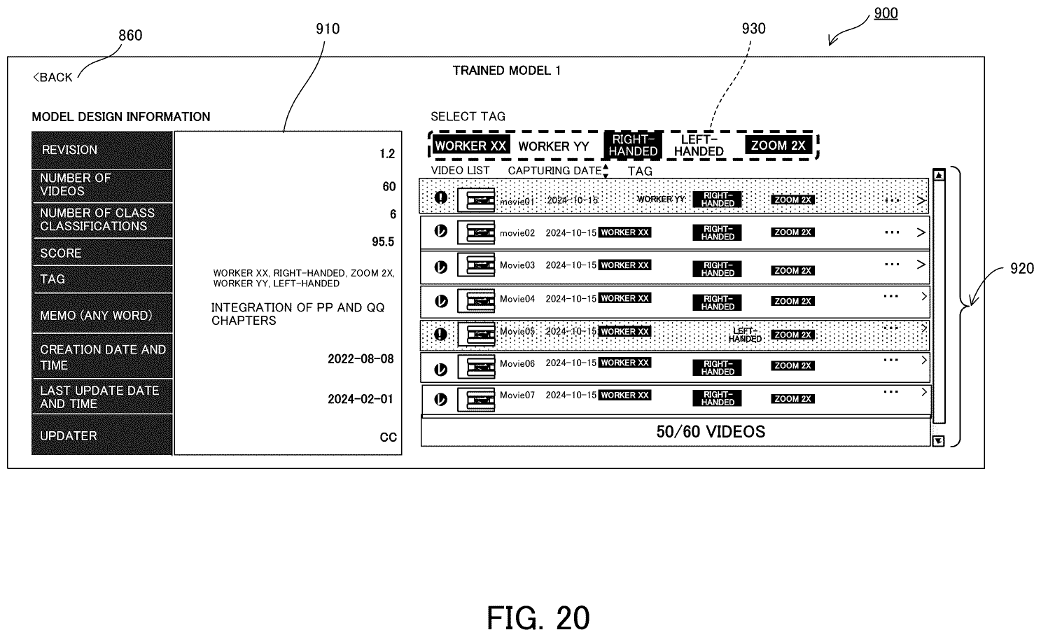

When the processing of FIG. 19 is started, first, in S161, a video tag information screen 900 exemplified in FIG. 20 is displayed on the monitor 300.

Here, the video tag information screen 900 exemplified in FIG. 20 will be described.

The video tag information screen 900 is a screen that indicates tag information attached to data of the training video in association with the training video for each training video used for machine learning at the time of creating the trained model. By referring to the video tag information screen 900, the model developer can easily grasp the situation at the time of acquiring the training videos.

The video tag information screen 900 includes a design information display area 910, a tag information list display area 920, and a tag information selection area 930.

The design information display area 910 is an area in which design information is displayed for the selected trained model (the trained model of the latest revision in a case where there are a plurality of revisions of the trained model).

The tag information list display area 920 is an area for displaying a list of training videos used for learning at the time of creating the trained model of the revision for which design information is displayed in the design information display area 910 and the tag information attached to the respective pieces of data of the training videos in association with each other.

The tag information selection area 930 is an area for individually selecting tag information among the design information for the trained model of the revision displayed in the design information display area 910.

In the example of FIG. 20, five items, “worker XX”, “right-handed”, “zoom 2X”, “worker YY”, and “left-handed”, are shown as tag information in the design information display area 910. These are tag information attached to any of the training videos used for learning at the time of creating the trained model of the revision for the design information is displayed in the design information display area 910. These five items are displayed in the tag information selection area 930.

When click operations are performed on these items displayed in the tag information selection area 930, the item on which the click operation has been performed is displayed in an inverted display mode (a mode in which white characters representing the item are shown on a black background). At this time, the display mode also changes to the inverted display mode for the tag information of the same item displayed in association with the training videos in the tag information list display area 920.

In the example of FIG. 20, three items, “worker XX”, “right-handed”, and “zoom 2X”, among the five items displayed in the tag information selection area 930 are displayed in the inverted display mode, indicating that these three items are selected. Furthermore, it is illustrated in FIG. 20 that the tag information “worker XX”, “right-handed”, and “zoom 2X” displayed in association with the training videos in the tag information list display area 920 is changed to be displayed in the inverted display mode by this selection.

As described above, in response to the reception of the selection of the tag information in the tag information selection area 930, the selected tag information and the training videos related to the selected tag information are displayed on the video tag information screen 900. By displaying such a video tag information screen 900 on the monitor 300, it is possible to provide the model developer with a determination material for selecting training videos in re-learning for updating the trained model.

Returning to the description with reference to FIG. 19, in the processing of S161, first, design information is acquired for the selected trained model (the trained model of the latest revision in a case where there are a plurality of revisions of the trained model). Then, the display of the design information display area 910 is created using the acquired design information. Furthermore, by referring to the model-related file information DB 600 at this time, video files of training videos used for learning at the time of creating the selected trained model are specified. Then, the tag information is acquired from the video files, and the display of the tag information list display area 920 is created by associating the acquired tag information and the training video for each training video. Furthermore, the display of the tag information selection area 930 is created using the tag information included in the design information displayed in the design information display area 910. The processor 201 displays the video tag information screen 900 in which the display of each area is created in this manner on the monitor 300.

Next, in S162, an instruction operation on the input device 400 is acquired. Then, in S163, it is determined whether the acquired instruction operation is an operation of clicking any of the tag information displayed in the tag information selection area 930.

When it is determined in the processing of S163 that the instruction operation is an operation of clicking the tag information, tag information that is the same as the one on which the click operation has been performed in the tag information list display area 920 and the tag information selection area 930 are displayed in an inverted manner in S164. Thereafter, the processing returns to S162, and the processing continues by acquiring an instruction operation on the input device 400.

On the other hand, when it is determined in the processing of S163 that the instruction operation is not an operation of clicking the tag information, it is determined whether the instruction operation is an operation of clicking a back button 940 included in the video tag information screen 900 in S165. In this determination processing, when it is determined that the instruction operation is an operation of clicking the back button 940, this video tag information screen processing ends, and the processing is returned to the original processing, that is, the annotation work screen processing in FIG. 10.

On the other hand, when it is determined in the determination processing of S165 that the instruction operation is not an operation of clicking the back button 940, the processing returns to S162, and an instruction operation on the input device 400 is acquired again.

### [10: Re-Learning Processing]

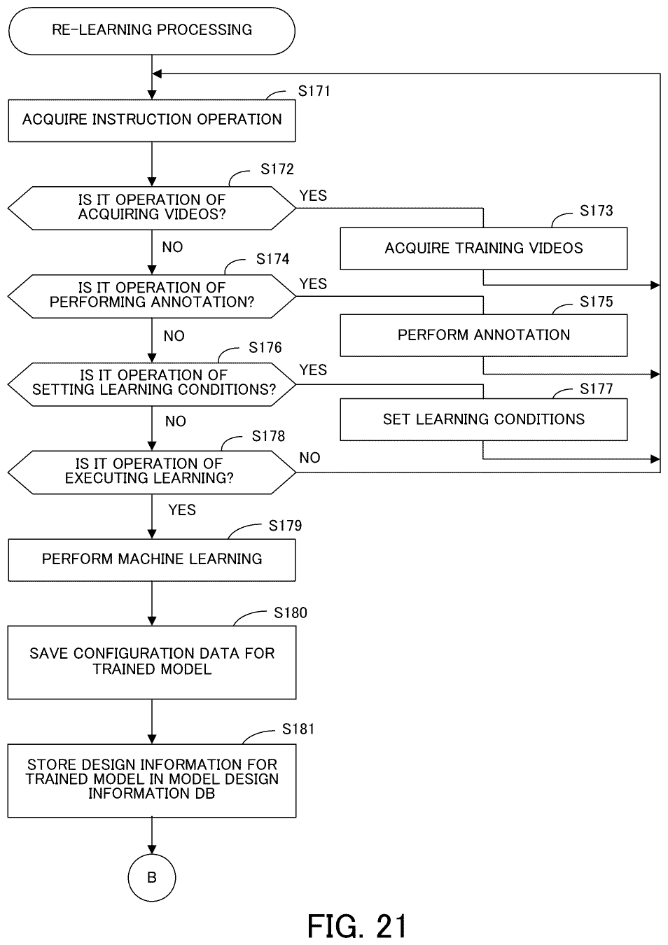

Next, re-learning processing will be described. FIG. 21 is a flowchart illustrating processing contents in the re-learning processing.

The re-learning processing is executed by the processor 201 as the processing of S115 in a case where the instruction operation acquired by the processing of S113 in the annotation work screen processing of FIG. 10 is an operation of clicking an AI model creation button 864 included in the annotation work screen 800.

The model developer performs the work in S21 of FIG. 2, and grasps the intention and the background of the design at the time of creating the old version of the AI model. Thereafter, the model developer performs the subsequent review work in S22, and performs the work in and after S23 according to the result of the review. The re-learning processing is processing for the work in and after S23.

When the execution of the processing of FIG. 21 is started, first, in S171, an instruction operation on the input device 400 is acquired. Then, in the subsequent determination processing of each of S172, S174, S176, and S178, the instruction content indicated by the instruction operation is determined.

When it is determined in the determination processing of S172 that the instruction operation indicates an instruction to acquire videos, training videos are acquired in S173. This processing is processing for acquiring training videos, and is processing for work of additionally acquiring training videos, which is the work in S24 of the AI model update work illustrated in FIG. 2.

When it is determined in the determination processing of S174 that the instruction operation indicates an instruction to execute annotation, annotation is performed in S175. This processing is processing for adding annotations to the training videos, and is processing for assigning annotations to the training videos or changing the assigned annotations, which is the work in S26 of the AI model update work illustrated in FIG. 2. Note that this processing includes the annotation work support processing for re-learning illustrated in FIG. 8.

When it is determined in the determination processing of S176 that the instruction operation indicates an instruction to set learning conditions, learning conditions are set in S177. This processing is processing for setting learning conditions in machine learning for creating an AI model, and is processing for work of resetting learning conditions, which is the work in S28 of the AI model update work illustrated in FIG. 2.

When the processing of S173, S175, or S177 described above ends, the processing returns to S171, and a new instruction operation is acquired again.

On the other hand, when it is determined in the determination processing of S178 that the instruction operation indicates an instruction to execute machine learning, machine learning is performed in S179. This processing is processing for performing machine learning to create an AI model according to the set learning conditions, and is processing for the work in the procedures of S15 to S20 in FIG. 1 as re-learning in the AI model update work.

Thereafter, when the machine learning of S179 is completed, configuration data for the trained model created by the machine learning after re-learning is saved in the storage 203 in S180. Then, in subsequent S181, design information for the trained model obtained after re-learning is stored in the model design information DB 500 of the storage 203 in association with a revision that is version information indicating the version of the trained model obtained after re-learning. In addition, in S181, the trained model obtained after re-learning and various data files related thereto (video files for learning, annotation files, and classification criterion files) are registered in the model-related file information DB 600 of the storage 203 in association with the revision of the trained model obtained after re-learning.

After the processing of S181 ends, the re-learning processing ends, the processing proceeds to the annotation work support processing for re-learning illustrated in FIG. 8, and the processing of S101, which is processing for displaying the model selection screen 700, is performed.

When the instruction content indicated by the instruction operation cannot be determined by any of the determination processing of S172, S174, S176, and S178, the processing returns to S171, and a new instruction operation is acquired again.

The processing described so far is re-learning processing.

As described above, the annotation work support system 1 is configured to present training videos and annotation information associated with a trained model in association with each other, and present classification criterion information associated with the trained model. By doing so, it is easy to grasp information regarding annotation work performed previously. Since the annotation work support system 1 is configured as described above, it is possible to support annotation work for re-training the trained model, and the model developer who performs annotation work can easily perform the annotation work.

The above-described embodiments are specific examples to facilitate understanding of the invention, and the present invention is not limited to these embodiments. Modifications obtained by modifying the above-described embodiments and alternatives to the above-described embodiments may also be included. That is, in the above-described embodiments, the components can be modified without departing from the spirit and scope thereof. In addition, new embodiments can be implemented by appropriately combining a plurality of components disclosed in the above-described embodiments. Furthermore, some components may be omitted from among the components described in the embodiments, or some components may be added to the components described in the embodiments. Furthermore, the processing procedures described in the embodiments may be changed as long as there is no contradiction. That is, the annotation work support system according to the present invention can be variously modified and altered without departing from the scope defined by the claims.

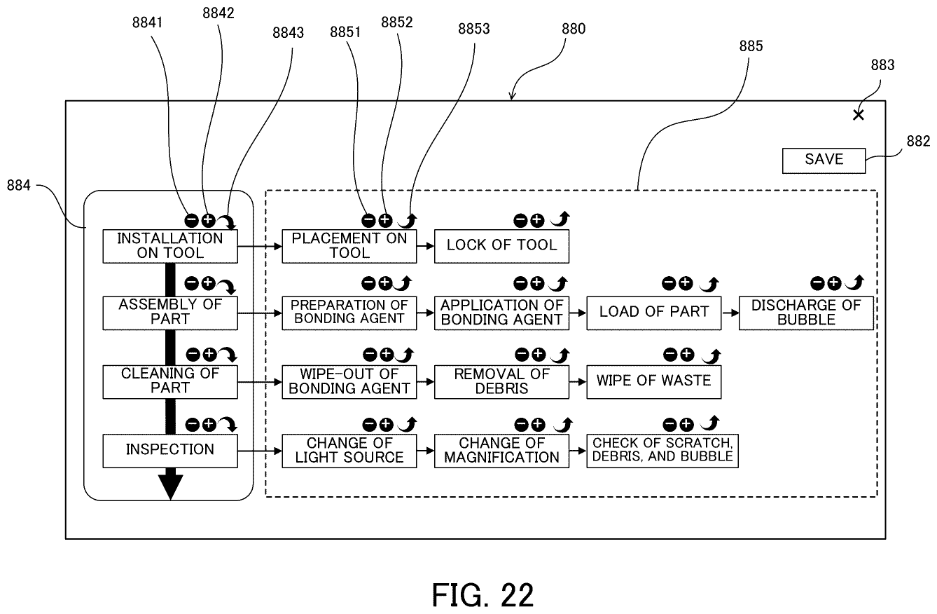

For example, in the above-described embodiments, the classification criterion information is shown in the form of a flowchart on the classification criterion information screen 880 displayed in the popped-up manner on the monitor 300 displaying the annotation work screen 800 exemplified in FIG. 14. Alternatively, the classification criterion information may be shown in another manner. FIG. 22 is a diagram illustrating another example of the classification criterion information screen 880.

The classification criterion information screen 880 exemplified in FIG. 22 includes display areas 884 and 885. The display area 884 is an area in which classifications of video segments are displayed. The display area 885 is an area in which tasks included in the classifications of the video segments are displayed. In the example of FIG. 22, it is shown that tasks included in the classification “installation on tool” are “placement on tool” and “lock of tool”.

By displaying the classification criterion information screen 880 exemplified in FIG. 22, the model developer who performs annotation work can check what tasks are specifically included in the classification of each video segment.

Note that the display area 884 further includes a classification deletion button 8841, a classification addition button 8842, and a demotion button 8843 corresponding to each displayed classification. When a click operation is performed on such a button, the processor 201 performs processing as follows. When a click operation is performed on the classification deletion button 8841, the corresponding classification is deleted. When a click operation is performed on the classification addition button 8842, a new classification is added as a classification that is a process before or after the corresponding classification. When a click operation is performed on the demote button 8843, the corresponding classification is demoted to a task. More specifically, tasks included in the corresponding classification are tasks to be performed after a last task included in a classification that is a process before the corresponding classification or tasks to be performed before a first task included in a classification that is a process after the corresponding classification.

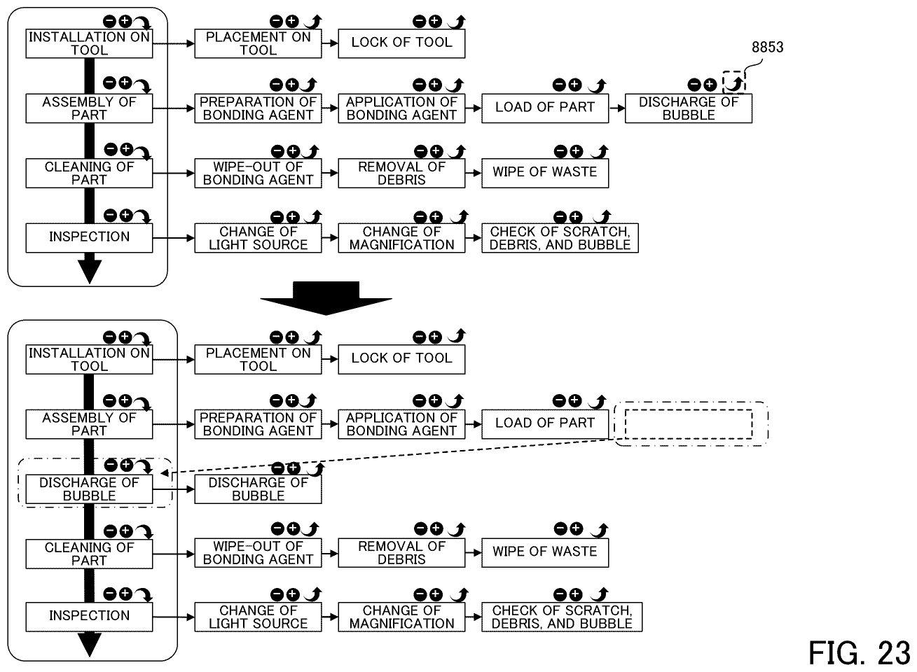

The display area 885 further includes a task deletion button 8851, a task addition button 8852, and a promotion button 8853 corresponding to each displayed task. When a click operation is performed on such a button, the processor 201 performs processing as follows. When a click operation is performed on the task deletion button 8851, the corresponding task is deleted. When a click operation is performed on the task addition button 8852, a new task is added as a task before or after the corresponding task. When a click operation is performed on the promotion button 8853, the corresponding task is promoted to a classification. More specifically, the corresponding task is changed to a classification that is a process after the classification including the corresponding task. For example, as exemplified in FIG. 23, when a click operation is performed on the promotion button 8853 corresponding to task “discharge of bubble” included in the classification “assembly of part”, the task “discharge of bubble” is changed to classification “discharge of bubble”, which is a process after the classification “assembly of part”. In this case, since the task “discharge of bubble” is one task, the task included in the promoted classification “discharge of bubble” is only the task “discharge of bubble”.

According to the classification criterion information screen 880 in the example of FIG. 22, the model developer who performs annotation work can edit the classification criterion information by performing an operation of clicking each of the classification deletion button 8841, the classification addition button 8842, the demotion button 8843, the task deletion button 8851, the task addition button 8852, and the promotion button 8853. The edit of the classification criterion information is useful, for example, in a case where it is desired to manage what is managed as a classification as a task included in the classification or in a case where it is desired to manage what is managed as a task included in a classification as another classification.

Furthermore, for example, in the above-described embodiments, the display size of the video segment screen 870 (see FIG. 11) or the classification criterion information screen 880 (see FIG. 14) displayed in the popped-up manner on the monitor 300 displaying the annotation work screen 800 may be changed according to an instruction operation on the input device 400.

In addition, for example, in the above-described embodiments, the configuration data for the trained model, the model design information DB 500, and the model-related file information DB 600 are individually stored in the storage 203 of the computer 200a as the control device 200. Alternatively, the design information stored in the model design information DB 500 and the information on various file names stored in the model-related file information DB 600 may be embedded in the configuration data of the corresponding version of the trained model and individually stored in the storage 203.

Note that, in the present specification, the expression “on the basis of A” does not indicate “on the basis of only A” but means “on the basis of at least A” and further means “partially on the basis of at least A”. That is, “on the basis of A” may mean “on the basis of B in addition to A” or “on the basis of a part of A”.

What is claimed is:

1. An annotation work support system comprising:
a storage and a processor,
wherein the storage is configured to store:
at least one trained models trained using at least one microscopic videos;
microscopic videos associated with each of the trained models;
annotation information indicating annotations assigned to the microscopic videos associated with each of the trained models, the annotation information including classifications for video segments included in the microscopic videos; and
classification criterion information indicating a classification assignment criterion associated with each of the trained models, and
the processor is configured to:
receive a selection of at least one of the trained models;
acquire microscopic videos, annotation information, and classification criterion information associated with the selected trained model from the storage;
display the acquired microscopic videos and the acquired annotation information in association with each other on a display; and
display the acquired classification criterion information on the display.

2. The annotation work support system according to claim 1, wherein
the storage is further configured to store design information associated with each of the trained models, and
the processor is further configured to display some of the design information associated with the selected trained model in association with the microscopic videos on the display.

3. The annotation work support system according to claim 2, wherein
the design information includes tag information,
the storage is further configured to store the tag information in association with the microscopic videos, and
the processor is further configured to:
receive a selection among the tag information;
display the selected tag information and microscopic videos associated with the selected tag information in association with each other on the display.

4. The annotation work support system according to claim 1, wherein the processor is configured to receive the selection of the at least one of the trained models by using a selection screen displayed on the display.

5. The annotation work support system according to claim 1, wherein the processor is configured to display the classifications included in the annotation information as a list on the display.

6. The annotation work support system according to claim 5, wherein the processor is further configured to:
receive a designated classification among the classifications in the list; and
display a video segment to which the designated classification is assigned on the display.

7. The annotation work support system according to claim 1, wherein
the processor is further configured to receive an addition, a deletion, or a correction of an annotation in the displayed annotation information, and
the storage is further configured to store the updated annotation information.

8. The annotation work support system according to claim 1, wherein the classification criterion information includes a classification assignment procedure when the annotations are assigned to the microscopic videos.

9. The annotation work support system according to claim 8, wherein
the processor is further configured to receive an addition, a deletion, or a correction of a classification assignment procedure in the displayed classification criterion information, and
the storage is further configured to store the updated classification criterion information.

10. An annotation work support method performed by a computer, the annotation work support method comprising:
receiving a selection of at least one trained model trained using at least one microscopic videos;
acquiring the microscopic videos, annotation information, and classification criterion information associated with the selected trained model from a storage that stores at least one trained models, microscopic videos associated with each of the trained models, annotation information indicating annotations assigned to the microscopic videos associated with each of the trained models, the annotation information including classifications for video segments included in the microscopic videos, and classification criterion information indicating a classification assignment criterion associated with each of the trained models;
displaying the acquired microscopic videos and the acquired annotation information in association with each other on a display; and
displaying the acquired classification criterion information on the display.

11. A computer-readable storage medium storing an annotation work support program causing a computer to perform:
receiving a selection of at least one trained model trained using at least one microscopic videos;
acquiring the microscopic videos, annotation information, and classification criterion information associated with the selected trained model from a storage that stores at least one trained models, microscopic videos associated with each of the trained models, annotation information indicating annotations assigned to the microscopic videos associated with each of the trained models, the annotation information including classifications for video segments included in the microscopic videos, and classification criterion information indicating the classification assignment criterion associated with each of the trained models;
displaying the acquired microscopic videos and the acquired annotation information in association with each other on a display; and
displaying the acquired classification criterion information on the display.
